(19) United States
(12) Patent Application Publication
(10) Pub. No.: US 2002/0136862 A1
(43) Pub. Date: Sep. 26, 2002

(54) Decorative and/or flame retardant laminates and processes of manufacture thereof

(76) Inventors: Daojie Dong, Westerville, OH (US); Galen R. Dudgeon, Newark, OH (US); James V. Gauchel, Newark, OH (US); John Giacalone, (US); Dale A. Grove, Pickerington, OH (US); Diane M. Hulett, Glenford, OH (US); Yein-Ming L. Lee, Westerville, OH (US); Jeff Tigner, (US)

Correspondence Address: OWENS CORNING, 2790 COLUMBUS ROAD, GRANVILLE, OH, 43023, US

(21) Appl. No.: 09/734,104

(22) Filed: Dec. 11, 2000

(51) Int. Cl. B32B 3/00; B32B 5/12

(52) U.S. Cl. 428/150; 428/106; 428/479.6; 428/195

(57) ABSTRACT

The present invention refers to multi-layered decorative laminates including a decorative layer, such as a wood veneer layer, and one or more reinforced polymer layer(s), such as a reinforced polyvinyl chloride (PVC) layer. Methods of making and using such laminates and of producing overly and underlay layers, which supplement the decorative layer, are described herein. The invention also relates to laminates of improved fire resistance including reinforced polymer layers.

### CROSS REFERENCE TO RELATED APPLICATIONS

This application is related to U.S. Application Ser. No. 09/596,065, filed Jun. 16, 2000 and U.S. Pat. No. 6,093,359. The entire disclosure of the application and patent is hereby incorporated by reference in its entirety.

### TECHNICAL FIELD AND INDUSTRIAL APPLICABILITY OF THE INVENTION

The present invention relates to multi-layered decorative laminates including a decorative layer, such as a wood veneer layer, and one or more reinforced polymer layers, such as a reinforced polyvinyl chloride (PVC) layer, and to methods of making and using such laminates and of producing overlay and underlay layers, which supplement the decorative layer. The invention also relates to laminates of improved fire resistance including two or more reinforced polymer layers.

### SUMMARY OF THE INVENTION

A need exists to provide decorative and/or fire resistant laminates having one or more improved properties, such as higher moisture resistance, printability, flexibility, and reduced optical distortion. There is also a desire to provide underlay and overlay layers useful with a wide variety of decorative layers, including those based on paper, polymer, or wood veneer.

In accordance with these needs, the first part of the invention describes a decorative laminate comprising:

a) an optional overlay comprised of a reinforced polymeric layer formed by preparing a non-woven, fibrous, fully dispersed, wet-laid compound by mixing a suspension comprising a reinforcement material, at least one particulate thermoplastic polymer, and optional additives for imparting additional wear resistance to the laminate, in an aqueous medium to form a white water slurry, dewatering the white water slurry to form a wet-laid compound impregnated with the particulate thermoplastic polymer, optional additives such as colorants to pigment the underlay, and drying and fusing the wet-laid compound to form a fiber-reinforced polymer layer,

b) a decorative layer,

c) an optional underlay optionally comprising additives, such as colorants, formed by preparing a non-woven, fibrous, fully or non-fully dispersed, wet-laid compound by mixing a suspension comprising a reinforcement material, at least one particulate thermoplastic polymer in an aqueous medium to form a white water slurry, dewatering the white water slurry to form a wet-laid compound impregnated with the particulate thermoplastic polymer, and drying and fusing the wet-laid compound to form a fiber-reinforced polymer layer, and

d) an optional substrate layer,

with the proviso that at least one layer of a) or c) exists.

In accordance with a second aspect of the invention, there is provided a laminate comprising

(i) a layer formed by preparing a non-woven, fibrous, fully or non-fully dispersed, wet-laid compound by mixing a suspension comprising a reinforcement material, at least one particulate thermoplastic polymer in an aqueous medium to form a white water slurry, dewatering the white water slurry to form a wet-laid compound impregnated with the particulate thermoplastic polymer, and drying and fusing the wet-laid compound to form a fiber-reinforced polymer layer, and

(ii) a fiber reinforced polypropylene layer.

The invention also relates to compression molded parts comprising an optional decorative layer and one or more reinforced polymers. Examples are compression molded parts for appliances such as washing machine lids as well as seat backs, door and instrument panels for automobiles.

Further objects, features, and advantages of the invention will become apparent from the detailed description that follows.

### BRIEF DESCRIPTION OF THE DRAWINGS

FIG. 1 is a two-dimensional drawing of a decorative laminate according to the present invention.

FIG. 2 is a representation of a process of forming a wet-laid, fibrous, non-woven mat useful in laminates of the present invention.

FIG. 3 is a schematic diagram of a double belt press molding process for molding composite laminates according to the present invention.

### DETAILED DESCRIPTION AND PREFERRED EMBODIMENTS OF THE INVENTION

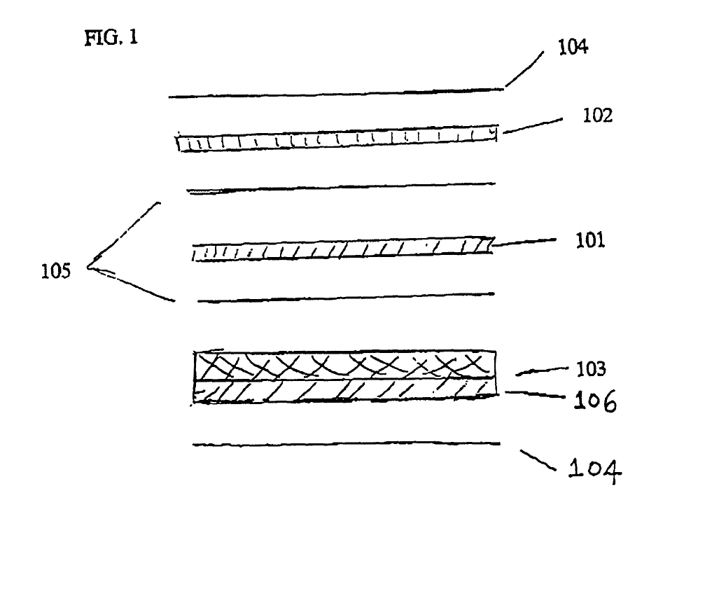

One aspect of the invention provides a decorative laminate including a decorative layer, and one or more of an underlay or overlay layer, and optionally a substrate. Reference is made to FIG. 1, which sets forth a representative arrangement of layers in decorative laminates of the invention.

Layers 104 are release layers, which aid in the manufacture process, but generally, are not part of the final product. Layer 102 is at least one overlay, layer 101 is at least one decorative layer, layer 103 is at least one underlay, and layer 106 is at least one substrate layer. Layers 105 are optional adhesives layers. The only required layer in the decorative laminates of the invention is at least one decorative layer.

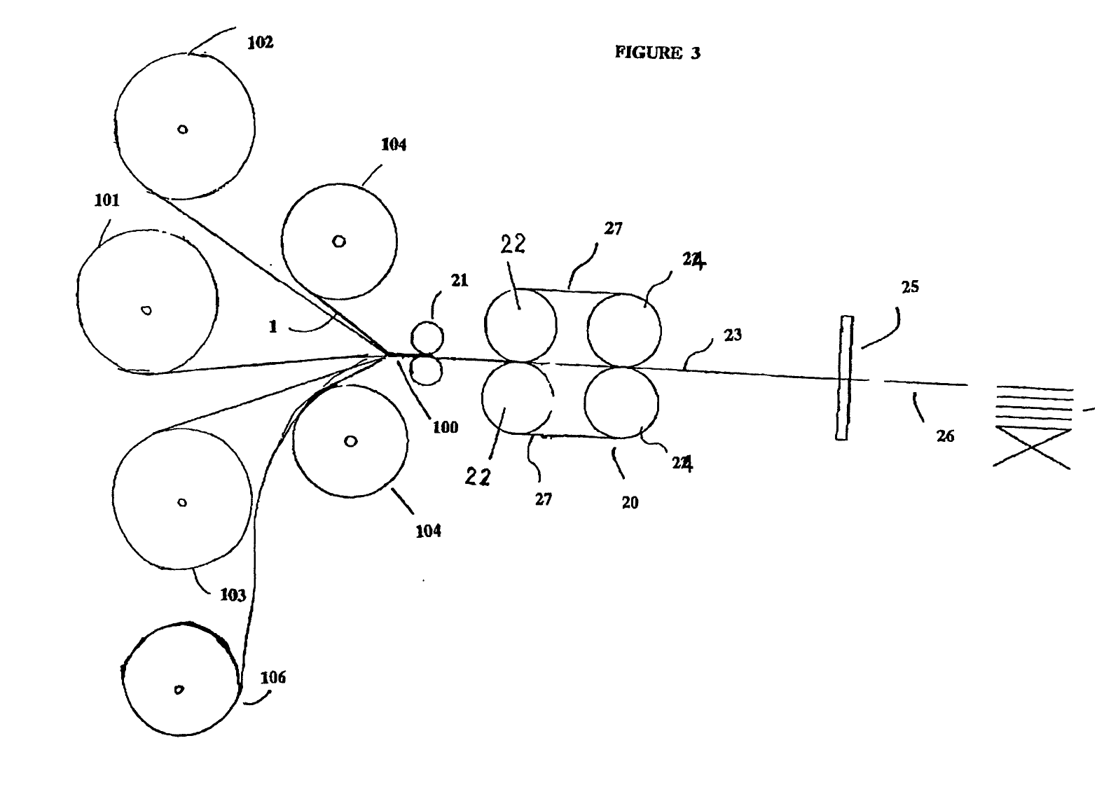

There can be more than one of each of the noted layers. For example, an arrangement from top to bottom in FIG. 3 of optional first overlay 102, decorative layer 101, underlay 103, substrate 106, second underlay, second decorative layer, and second optional overlay can be used, when it is desired to provide a laminate having two decorative sides.

The layers can be arranged in any suitable manner. An optional adhesive layer 105 may be used between each layer to aid in consolidating the laminate. But an advantage of the present invention is that such an adhesive layer is not required to form the laminate.

Decorative Layer

Any decorative layer or layers known in the art can be used in the laminates of the invention. Examples include decorative printed-paper or parchment, printed polymeric films (such as printed PVC or acrylic), wood veneers, reconstituted wood veneer, or the like.

The decorative image may be, but is not limited to, wood grains, stones, marbles, fabrics, or any other photographic picture. The decorative layer can be a film, such as a single layer reverse coated, multi-layer direct coated, or solid color without print film. In a preferred embodiment, the decorative image is a photographic image having a wood-grain appearance. The decorative image may be a solid color without a defined image.

Preferred printed organic films include printed PVC films, and reverse printed acrylic films with or without a PVC base color film.

The decorative layer may be composed of two layers: a carrier film and layer of ink. The layer of ink may be composed of a single sub-layer or multiple sub-layers depending on the design and colors used to make the image. Each sub-layer can be placed on the carrier film by a single printing role, which places a single color. The carrier film may be any type, e.g., of a polymer, but is preferably a PVC of low plasticizer content for example less than about 25 or less than about 20 parts per hundred resin (pphr). A preferred carrier film thickness is about 0.002″ to about 0.008″. The carrier film is printed as known in the art to develop a decorative image such as a wood grain. A printing line may be composed of 2-8 such printing rolls depending on the complexity of the printing operation. The registry of these sub-layers is controlled to ensure high quality multicolor prints.

The carrier film preferably has less than about 25 pphr plasticizer, for example, about 10 to about 25 pphr of plasticizer to minimize flow of the resin of the carrier film during the molding process, and maintain ink registration during the molding process. The lower limit of plasticizer is set by the ability of the inks to be accepted by the film. The upper limit of plasticizer is set by the molding process used to place the decorative layer in the laminate. Films with higher level of plasticizer can tend to blister and distort in subsequent laminating or molding processes.

The inks can be selected from the results of accelerated weathering tests using such equipment as a XENON ARC weatherometer and QUV weatherometer. Inks preferably should maintain color and intensity after extend exposure (circa 2000 hrs and 50° F. above the service temperature of the application) to temperature and light in order to be certified for use in areas where elevated temperature and UV exposure are common.

A polymeric protective layer can be on the ink layer. Such a layer should preferably be both UV resistant and clear. UV and thermal resistant inks are preferred so the color and placement of the ink remains constant throughout the molding process and throughout the use of the product. A particularly useful protective layer is an acrylic weathering layer. For example, a UV stabilized acrylic sheet may be bonded to a standard decorative layer comprising a carrier film and a layer of ink to form an outdoor capable decorative system. A two-step process may be used to form the system. For example first the decorative layer is made, then the outer ink layer of the decorative layer is bonded to the acrylic film using heat and pressure in a lamination operation. The resulting multi-layer film is then handled as a standard decorative layer.

Another useful decorative layer is a reverse printed film comprising a carrier film and a print layer. Here the image is formed in such a way that the viewer sees the correct image when looking through a carrier film rather than directly at the print film. Reverse printing allows the carrier film to be multifunctional i.e., act as both a method for placing the print into the part and act as a performance enhancing layer such as a weathering or wear layer. Moreover a reverse printed film can be used in combination with a solid colored secondary film to create the desired image such as wood-grain, tile, marble, or the like, e.g. by placing the secondary film below the reverse printed film.

A paper based decorative film and/or paper-based overlay described below, may be treated with thermoset resins, such as polyesters or melamine, to provide surface hardness and heat resistance on the final cured decorative laminate.

Real wood veneer, such as cherry, walnut, mahogany, oak, cedar, and the like are preferred decorative layers. Such layers can be treated with lacquers or the like as known in the art.

Overlay

Any desired overlay(s) can be used in the decorative or fire retardant (discussed below) laminates of the invention to provide desired features. For example, the overlay may have different formulations to provide desired levels of wear resistance. For example, a high wear resistant overlay is preferred when the intended application is, for example, a counter top or flooring. Conventional overlays used in the art, such as paper based layers can be used. However, a fiber-reinforced polymeric overlay is often preferred.

Exemplary overlays include a paper base wear resistant overlay. The paper base wear resistant overlay can be a paper filled with aluminum oxide or other particles that provide wear resistance, as a wear resistant media, treated with melamine resin. Such overlays are commercially available. Such paper-based overlays, however, have limited application in wet environments, such as bathrooms, showers, and the like, due to their poor stability in such environments.

A preferred overlay comprises a reinforced polymeric layer formed by preparing a non-woven, fibrous, fully dispersed, wet-laid compound by mixing a suspension comprising a reinforcement material, at least one particulate thermoplastic polymer, and optional additives for imparting additional wear resistance to the laminate, in an aqueous medium to form a white water slurry, dewatering the white water slurry to form a wet-laid compound impregnated with the particulate thermoplastic polymer, and drying and fusing the wet-laid compound to form a fiber-reinforced polymer layer.

Preferred overlays can include glass fiber-reinforced polyvinyl chloride with substantially no optional wear-resistance additives. Such an overlay preferably comprises fully dispersed wet used chopped strand glass fibers having a fiber diameter from about 11 to about 17 microns, and a fiber length of about 10 to about 18 millimeters, such as wet used chopped strand glass fibers have a diameter of about 13 microns and a length of about 12.5 millimeters.

Other preferred overlays comprises glass fiber reinforced polyvinyl chloride with one or more additives to improve wear resistance of the laminate and reduce moisture permeability while maintaining transparency. The additives are preferably glass beads, flake glass, and/or wet used chopped strand glass fibers having a length of less than about 0.25″ and a diameter of less than about 11 microns. Preferred additives include wet used chopped strand glass fibers having a diameter of about 7 microns and a length of about 0.125 inches.

The amount of optional additive and fiber-reinforcement is selected to provide desired wear resistance, while maintaining desired transparency. For example, a total weight percent of reinforcement plus additives in the overlay can be between about 20 and about 28% by weight of the total weight of the overlay.

A preferred wear overlay is an unconsolidated polymeric composite such as described below and in U.S. application Ser. No. 09/596,065 filed Jun. 16, 2000 (incorporated by reference herein), Other preferred overlays include a fiber reinforced veil (generally a glass veil that includes polymer) and a polymer layer (such as a film or coating) above the veil. Exemplary polymer layers include acrylic UV resistant films, polyurethane films, a PVC UV resistant film, or other films which give desired properties. The polymer film should provide desired properties and maintain transparency. The fiber-reinforced veil should preferably be transparent, hence glass fibers are the preferred reinforcement.

An exemplary combination of decorative layer, overlay, and underlay is a melamine treated paper-based wear resistant overlay, an untreated dry printed decorative paper, and unconsolidated reinforced polymer composites underlay.

The wear layer can provide the desired functional properties, such as wear resistance, UV stability, color stability, scratch resistance, optical clarity, and the like, to the laminate. The overlay can be the same as the underlay layers described below, but include additives or polymer to give the desired functional characteristics. Also, the overlay should preferably be transparent so that the image of the decorative layer will transmit as intended.

A clear wear overlay may comprise a clear PVC or acrylic matrix containing essentially clear, abrasion-resistant glass beads, glass flake or sodium silicate. An effective amount of additive to give desired wear resistance can be used, for example, up to about 8% by weight. For certain application, wear additives are not needed, since the glass in the reinforced polymer overlay provides desired wear properties. The wear layers of the present invention can provide wear resistance at least as acceptable as commercially available products. The wear layer is layered upon the decorative layer, which is layered upon a substrate or overlay, such as a clear fiber reinforced polymeric substrate layer or layered veil. The clear wear overlay layer is especially useful for flooring.

The wear overlay can be manufactured by a process including: preparing an aqueous suspension of solution polymerizable polymer, e.g., vinyl monomer or polymer; adding wear additives such as glass fibers, glass beads, glass flake or sodium silicate to the polymer suspension; and removing sufficient aqueous medium to recover a moldable composition. The moldable composition is then converted to a clear film matrix laminate on a consolidated composite.

The wear-overlay layer may be produced using the processing technology described below and in U.S. Pat. No. 6,093,359. The fiber length and consistency of the slurry are adjusted to give maximum dispersion so that preferably no bundles of glass will be visible when the wear overlay layer is molded over the decorative layer. Fiber diameters ranging from about 7 micron to about 17 micron and fiber lengths ranging from about 12.5 millimeter to about 17 millimeter can be formed into wear overlay layers of weights ranging from about 0.03 lb/ft² to about 0.08 lb/ft² with resin levels of about 75% to about 90% by weight.

As mentioned above, additives such as glass beads, glass flake, shorter length chopped glass fibers (wet use chopped strands—WUCS), sodium silicate, or other hard fillers, which have the proper refractive index to be invisible in the molded wear overlay layer, may also be included to enhance wear, weathering, and/or stain resistance. Resins used for the wear overlay should be clear and of a similar refractive index to glass (1.35-1.70 preferably 1.47). The resin is preferably weatherable (color stable under UV exposure), and durable (resists scratching and staining), as disclosed in NEMA LD 3 standard for performance properties of wear layers and tests for determining rankings of said layers.

The additives can improve wear resistance of the laminate and reduce permeability of the decorative laminate to volatile species such as water and gasoline and other compounds to which it might be exposed.

Wear overlay layers can be added to the decorative layer and consolidated simultaneously in a single step molding process as described in more detail below. Pressure and temperatures are adjusted for minimum flow to maintain print fidelity of the decorative layer.

A preferred overlay comprises a wet laid glass veil with an appropriate layer, e.g. liquid coating or film, of resin, above the veil. The film preferably is a weatherable polymer (has colorfastness when exposed to outside elements) such as an UV stabilized PVC, a urethane, acrylic or the like. Preferably a clear acrylic film KORAD® produced by Polymer Extruded Products Inc. is used. Film thickness should be sufficient to supply enough polymer to wet out the reinforcing veil with enough resin left over for bonding and creating a smooth outer surface. Normally a 0.0025″ to 0.0035″, e.g. 0.003″ thick film will have sufficient material to handle the needs of 30 g/m² or 50 g/m² mat. A film of desired gloss should also be selected. KORAD® has both high and low gloss level films. A film with less than an 18 rating on 60° Hunter gloss meter is preferred.

The veil reinforcement can be made of wet laid glass fibers, such as ADVANTEX® glass produced by Owens Corning and more preferably, a wet laid veil bonded by an OCM524/ECR30A acrylic binder produced by Owens Corning. Other weights such as OCM524/ECR50A can also be used if the thickness of the film is adjusted. The veils can advantageously provide initial clarity and have little spring back when molding, thereby maintaining clarity in the final product.

The laminate of the present invention including the wear overlay may be used in numerous applications, such as, flooring, worktops, wall covering, desktop, furniture, electrical and appliance housings, cabinet doors (kitchen, bathroom, TV, etc.), and the like where wear-resistance is needed. The wear overlay provides suitable wear resistance and optical compatibility (clarity) to the laminates of the invention. The wear overlay obviates the need to employ opaque or optically distorting materials as wear-resistant agents in the top layer of decorative flooring composites.

Underlay

The decorative laminates or fire-retardant laminates discussed below, can also include one or more underlays (also known as a print through prevention layer) located below the decorative layer. The optional underlay should be thick enough to prevent telegraphing of defects from the substrate (such as a wood substrate and/or a reinforced polymeric substrate), to and through the decorative layer and hence becoming visible on the laminate surface, and itself should not contain defects that would telegraph through the decorative layer. An especially useful underlay is a fully dispersed layer of at least 5 pounds per 100 square feet in weight, having a glass content of greater than about 17%.

Useful underlays include reinforced polymer layers as described below, or a glass or other fiber veil having a polymeric layer, such as a coating or film, e.g. a PVC film, on one or both sides of the veil. Such an underlay can be selected from the veil/polymer combinations discussed above with respect to the overlay. However, the properties needed for the overlay, such as UV resistance and clarity are generally not needed for the underlay. Therefore, a wider selection of resins and additives can be used in such layer.

Standard underlays used in the art can also be used, such as those based on PVC or paper-based underlays.

As indicated above, the print through prevention layer should be of sufficient thickness to prevent these defects from becoming visible in the decorative layer. The thickness will vary depending of the make-up of the laminate and the type of decorative layer. For a soft decorative layer, like plastic decorative layers, the print through prevention layer may be reinforced with fully dispersed fibers. For a more rigid decorative layer, such as wood veneer, the print through prevention layer may contain limited amounts of bundled fibers, and hence not be fully dispersed. The print through prevention layer should be matched to the decorative layer and molding conditions such that few if any defects from the substrate telegraph through the final molded/bonded part.

The print through prevention layer may be made similar to the optional wear overlay layer, except weatherability resins or additives are not required. Rigid PVC is a preferred underlay, especially if the substrate or decorative layer contains PVC. Clarity is not essential in the underlayer, so long as there is no undesired transmittance through the decorative layer.

A preferred underlay is formed by preparing a non-woven, fibrous, fully or non-fully dispersed, wet-laid compound by mixing a suspension comprising a reinforcement material, at least one particulate thermoplastic polymer in an aqueous medium to form a white water slurry, dewatering the white water slurry to form a wet-laid compound impregnated with the particulate thermoplastic polymer, and drying and fusing the wet-laid compound to form a fiber-reinforced polymer layer.

A preferred underlay comprises fully dispersed wet used chopped strand glass fibers having a fiber diameter from about 11 to about 17 microns, and a fiber length of about 10 to about 18 millimeters, for example, wherein the wet used chopped strand glass fibers have a diameter of about 13 microns and a length of about 17 millimeters.

Another preferred underlay comprises a wet laid glass veil with an appropriate layer (coating or film) of resin, on one or both sides thereof. Other reinforced veils besides those based on glass can be used, for example, carbon based or thermoplastic based veils. Thickness of the film should be sufficient to supply polymer required to wet out the reinforcing veil with resin left over for bonding to the rest of the laminate and create a smooth outer surface. For example, normally a 0.003″ thick film will have sufficient material to handle the needs of 30 g/m² or 50 g/m² glass veil.

For example, the veil reinforcement can be made of wet laid glass fibers with generally at least 0.002″ thickness PVC film or other polymer, such as acrylic to supply resin. The PVC film is preferably placed next to the decorative layer, and the veil is placed between the PVC and any substrate layer, such as a wood substrate or fiber reinforced polymeric substrate layer. Preferably a rigid PVC film with about 18 to about 22 pphr plasticizer, either pigmented or non-pigmented can be used as the film to impregnate the veil. Sufficient resin should be available to impregnate the veil and left over resin should be available to bond to the decorative layer.

A preferred veil is fully dispersed with minimal bundles and of sufficient weight/thickness to prevent a defect from telescoping through the decorative layer. Preferably the veil is at least 30 g veil/m². The binder can be present in, for example about 15-25 percent of the total veil.

A preferred print through prevention layer includes a layer of PVC film greater than 0.005″ thick with a layer of reinforcement veil. The veil reinforcement can be made of wet laid glass fibers, preferably ADVANTEX glass produced by Owens Corning and more specifically a wet laid veil bonded by an acrylic binder and designated as OCM524/ECR30A produced by Owens Corning. 30A denotes an acrylic binder of 30 g/m² weight. Other weights such as OCM524/ECR50A can also be used if the thickness of the film is adjusted. The PVC film should be selected for maximum flow that does not inhibit bonding to the veneer or other decorative layer.

An alternate method for attaching the veil to the decorative layer is to incorporate an adhesive, such as a polyurethane adhesive, such as Bemis film adhesive, to perform the bonding.

The underlays can be colored with, for example, pigments.

Substrate

The decorative laminate of the invention can be adhered to one or more substrates. Any desired substrate can be used. The substrate can be a one or more reinforced polymer layers, and/or can include an additional substrate such as particleboard or other wood substrate. The substrate can be consolidated with the rest of the laminate by using heat and pressure, and/or with an optional adhesive coating. The substrate can be a polymeric foam substrate.

Preferred substrates include metal, particle board, Medium Density Fiberboard, plywood, engineered wood panel, oriented stand board, wheatboard, strawboard, reconstituted cellulosic panels, polymeric foams, honeycomb structural panels, mineral filled polymer, concrete, or an unreinforced or reinforced polymeric layer. Preferred reinforced polymers are glass reinforced PVC or glass reinforced polypropylene.

Exemplary Reinforced Polymers for use in Overlay, Underlay, and/or Substrate

The underlay, overlay, and/or substrate can be formed from a reinforced polymer layer. A preferred reinforced polymer layer is a non-woven, fibrous, fully or partially dispersed wet laid fiber glass/polyvinyl chloride (PVC) compound formed into a mat. However, other types of polymer, and fiber reinforcement, as discussed below can be used, so long as they meet the functional requirements for the particular layer.

A reinforced polymer layer can be manufactured by using an aqueous suspension of discontinuous fibers, such as wet chopped glass fibers and an aqueous suspension of a polymer, such as PVC, generally with agitation in a mixing tank. The resulting combined aqueous suspension, often referred to as slush or pulping medium, may be processed into a wet-laid, sheet-like material by machines, such as a cylinder or Fourdinier machines or other technologically advanced machinery, such as the Stevens Former, Roto Former, Inver Former and the VertiFormer machines. The slush is deposited from a headbox onto a moving wire screen or onto the surface of a moving wire-covered cylinder. The slurry on the screen or cylinder is processed into the non-woven, sheet-like mat by the removal of water, usually by a suction and/or vacuum device. An exemplary process is illustrated in U.S. Pat. Nos. 5,393,379 and 6,093,359 both herein incorporated by reference in its entirety.

Any conventional paper making apparatus such as a sheet mold or a Fourdinier or cylinder machine may accomplish the sheet forming and dewatering process. After the mat is formed into a dewatered sheet, it may be desirable to densify the sheet by pressing it with a flat press or by sending it through calendaring rolls. Densification after drying of the mat is particularly useful for increasing the tensile and tear strength of the mat. Drying of the mat may be either hot-air-drying or oven drying.

The fiber-reinforced layer provides can contain from about 5% to about 80%, preferably about 10 to about 40% by weight of reinforcing material.

A fiber reinforced polymeric layer for use in one or more of the layers of the laminate of the invention, can be manufactured via reinforced composites from a materials system that is formed from an aqueous white water slurry. The term “materials system”, as used herein, includes a solid material comprising a fiber reinforcement material and a particulate polymer that is derived from a white water slurry, and which comprises an average moisture content of from 0 up to about 30% by weight. The materials system may be in the form of a wet-laid compound, which is a moldable semi-solid formed by dewatering the white water slurry, the resulting product having a water content of from about 2% by weight to about 30% by weight. The wet-laid compound may be dried to form a wet-laid mat having a moisture content of less than about 2% by weight, which may also be formed into intermediate products for further processing, or directly used in molding operations. At this point, the compound is still considered unconsolidated.

The aqueous white water slurry is comprised of fiber reinforcements and a particulate polymer, while preferably excluding a binder or other added resin such as would be used in traditional white water systems to bind the fiber reinforcements together. As used herein, the term “white water slurry” includes an aqueous slurry comprising a dispersion of one or more types of fiber reinforcements, one or more types of particulate polymers, and one or more other optional additives as may be desired to impart certain characteristics to the whitewater. The term “binder”, as used herein, means a resin in liquid or molten form, which is applied to, or incorporated with, a fiber reinforcement material to provide adhesion between the fibers thereof. As used herein, the term “in the absence of a binder” means that no binder is added at any point during the mat manufacturing step.

Useful fiber reinforcements include fully or partially dispersible materials. Preferred dispersible reinforcements include materials such as wet-used-chopped strands of glass, aramids, carbon, polyvinyl alcohol (PVA), hemp, jute, organic materials, mineral fibers and rayon. If the layer is used as an overlay, it is preferred that such layer remains clear or transparent when consolidated to a decorative layer. Therefore, only additives whose refractive indexes match the resin refractive index, such as glass, are preferably used in the overlay. However, other, non-index-matched fibers can be used if the layer is an underlay or substrate.

Such fibers may be in the form of rovings, strands or individual fibers that have been chopped or otherwise segmented into lengths varying from about ⅛ to 2.0 inch (about 3.2 to about 50.8 mm), designated herein as “long fibers”, and segments having a length of from about 1/32 to ⅛ inch (about 0.79 to 3.2 mm), designated herein as “short fibers”, and mixtures thereof. Suitably, the fibers of the reinforcement material may be of a diameter of from about 3 microns to about 90 microns. The fibers may be used in the form of strands comprised of from about 50 to about 4000 fibers. Preferably, the reinforcement material is a chopped long fiber glass prepared by chopping rovings comprising from about 200 to 4000 fibers, each having a diameter of from about 3 microns to about 25 microns, which may be used in wet or dry form.

The fibers of the reinforcement material are preferably surface treated with chemical sizing or coupling agents known in the art. Preferred sizings are selected so as to aid in dispersion without negatively affecting the dispersion properties of the white water slurry. Preferably the sizing composition is selected so as to aid in the dispersion of the reinforcement in the white water slurry. For example, a preferred sizing for a continuous glass roving reinforcement will allow for use of a wet roving i.e. having about 2 to about 19% by weight water. The preferred sizing should also be compatible with the particulate thermoplastic polymer such that the properties of the thermoplastic polymer in the white water slurry are optimized. Sizings are preferably water-based and may comprise one or more cross-linking agents, such as silanes, film-formers, surfactants, lubricants or other conventional additives. For example, where the fiber reinforcement is wet-used-chopped strand (WUCS), it may be purchased as a pre-sized product. Examples of such materials are wet-used chopped strand products sized with proprietary sizings 786, 9501 or 9502, which are commercially available under these designations from Owens Corning Inc.

When a particulate polymer such as polyvinyl chloride (PVC) is used in the white water slurry, a compatible sizing for the glass fiber reinforcement may comprise an amino silane such as: “A-1126”, which is a modified aminoorganosilane; “A-1120”, which is N-beta-(aminoethyl)-γ-(amino) propyltrimethoxysilane; “A-1102”, which is γ-(amino) propyltriethoxysilane; or “A-1100”, which is a γ-(amino)-propyltriethoxysilane; all of which are available from the Crompton Corporation.

| Tradename | Type |
|---|---|
| DYNASYLAN ® SILFIN- | Vinylsilane compounds containing |
| | peroxide and catalyst |
| DYNASYLAN ® VTMOEO | Vinyltris (2-methoxyethyoxy) silane |
| DYNASYLAN ® 6490 | Vinyltrimethoxysilane, oligomer |
| DYNASYLAN ® 6498 | Vinyltriethoxysilane, oligomer |
| DYNASYLAN ® 6598 | Vinyl-/Alkylsilane, oligomer |
| | Preparation, solvent-containing |
| DYNASYLAN ® 2201 | 3-Ureidopropyltrithoxysilane, |
| | 50% in methanol |
| DYNASYLAN ® 2220 | 3-Ureidopropyltrithoxysilane, |
| | Preparation |
| DYNASYLAN ® DAMO | N-Aminoethyl-3- |
| | Aminopropyltrimethoxysilane |
| DYNASYLAN ® DAMO-T | N-Aminoethyl-3- |
| | Aminopropyltrimethoxysilane, |
| | technical grade |
| DYNASYLAN ® TRIAMO | Triamino-functional |
| | Propyltrimethoxysilane |
| DYNASYLAN ® HS-types | Multifunctional organosilane |
| | oligomers, water-based, solvent-Free |
| DYNASYLAN ® IMEO | 3-(4,5-Dihydroimidazolyl) |
| | Propyltriethoxysilane |
| DYNASYLAN ® GLYMO | 3-Methacryloxypropyltrimethoxysilane |
| DYNASYLAN ® GLYEO | 3-Glycidyloxypropyltriethoxysilane |
| DYNASYLAN ® MTMO | 3-Mercaptopropyltrimethoxysilane |
| DYNASYLAN ® 4140 | Polyethersilane |
| DYNASYLAN ® VTC | Vinyltrichlorosilane |
| DYNASYLAN ® VTMO | Vinyltrimethoxsilane |
| DYNASYLAN ® VTEO | Vinyltriethoxysilane |
| DYNASYLAN ® AMMO | 3-Aminopropyltrimethoxysilane |
| DYNASYLAN ® AMEO | 3-Aminopropyltrietyhoxysilane |
| DYNASYLAN ® AMEO-T | aminosilane combination |
| DYNASYLAN ® 1126 | aminosilane combination |
| DYNASYLAN ® 1151 | Aqueous aminosilane combination |
| DYNASYLAN ® 1161 | Reaction product of DYNASYLAN |
| | DAMO and benzyl choloride, 50% in |
| | methanol |
| DYNASYLAN ® 1172 | Cationic, amino-functional silane, 50% |
| | in methanol |
| DYNASYLAN ® 1189 | N-(n-Butyl)-3- |
| | Aminopropyltrimethoxysilane |
| DYNASYLAN ® 1204 | aminosilane combination |
| DYNASYLAN ® 1211 | Polyglycol ether-modified |
| | aminosilane |
| DYNASYLAN ® 1411 | N-Aminoethyl-3- |
| | Aminopropylmethyldimethoxysilane, |
| | technical grade |
| DYNASYLAN ® 1505 | 3-Aminopropylmethyldiethoxysilane |
| DYNASYLAN ® 1506 | Amino-functional |
| | Propylmethyldiethoxysilane |

Preferably, the fiber reinforcement may be a sized glass reinforcement, which may be used wet, in continuous strand or chopped form. Typical water content for wet chopped strands ranges from about 10% to about 25% by weight. For continuous roving it ranges from about 2% to about 15% by weight. Most preferably, such a fiber reinforcement is used in wet, chopped form. An example of such a material is wet chopped strand of approximately 1¼-inch length and about 16 microns in diameter, which is commercially available from Owens Corning Inc. The wet chopped strand may be used unsized or sized with a compatible sizing.

The fiber reinforcement generally comprises from about 0.02% by weight to about 3% by weight of the white water slurry. Preferably, the amount of the fiber reinforcement comprises from about 0.03% by weight to about 0.1% by weight of the slurry before it is dewatered.

The white water system includes at least one particulate polymer, preferably thermoplastic polymer, such as PVC, acrylic or a mixture thereof, in the form of particles, granules or microspheres. A single polymer or blends of polymers may be used. Suitable particulate polymers may be either thermoplastic or thermosetting, and are typically in solid form at the temperature at which the white water is formulated. Suitably, the particulate polymer should also be heat fusible. The term “heat fusible”, as used herein, means that the polymer particles are capable of deformation under heat to conform to the surfaces of the filaments of the reinforcement material without melting, thereby joining the particles and the filaments to form a unitary structure. In this respect, the particulate polymer functions differently from the binder resins, such as urea-formaldehyde resins, that are conventionally used in the preparation of wet-laid materials, because such binder resins melt and flow readily to form an amorphous solid structure, with the polymer having accumulated a significant heat history in the process. The heat fusible particulate polymer is also desirably a hydrophobic, water insoluble polymer.

The particulate polymer should also be thermally stable. The term “thermally stable”, as used herein, means that the polymer has a relatively high degree of inherent stability and/or that a suitable thermal stabilizer is added to the polymer to impart the needed stability. Examples of such stabilizers include, but are not limited to, organometallic compounds such as alkyltin derivatives or mixed metal salts such as Ba/Zn carboxylates. Preferably, the stabilizers should be organometallic materials. Most preferably, the particulate polymer is a thermoplastic polymer, which may additionally be stabilized with butyltin thermal stabilizers.

Any desired particulate polymers can be used, for example, addition and condensation polymers such as, for example, PVC, polyolefins, polystyrenes, phenolics, epoxies, butadienes, acrylonitriles, and acrylics. A blend of polymers may also be used. The particulate polymer or blend of polymers may also include a heat stabilizer, which retards degradation of the particulate polymer.

Typically, the particle size of the polymer may be larger than the filament diameter of the reinforcement material. The average polymer particle size may range from about 10 microns to about 500 microns. Preferably, the average particle size may be from about 75 microns to about 200 microns, more preferably about 40 to about 130 microns. The particle size may be selected to optimize the performance of the polymer in the product, while minimizing waste. Where the particle size is too small, a large amount of the particulate polymer may be filtered out with the aqueous fraction when the whitewater slurry is dewatered. Conversely, where the particle size is too large, the particles do not become fully integrated between the filaments of the reinforcement material during dewatering; instead the particles accumulate on the surface of the product and block airflow during the drying step.

The particulate polymer should be of a molecular weight that provides improved impact resistance in composites. Preferably, for example, the inherent viscosity, which may be correlated to molecular weight, of the PVC particulate polymer is from about 0.5 to about 1.2, most preferably from about 0.50 to 0.95. It has been found, for example, that a particulate polyvinyl chloride having an inherent viscosity of either about 0.52 or 0.92 produces a composite with excellent impact resistance and good heat distortion properties.

The particulate polymer may, for example, be prepared as a dilute aqueous suspension containing monomeric molecules to be polymerized. The suspension may also contain an initiator, and, depending upon the polymer being formed, a heat stabilizer. The heat stabilizer may be added at the time of polymerization, or at any other convenient time during the process of manufacturing the polymer.

A preferred particulate thermoplastic polymer is a suspension-polymerized rigid polyvinyl chloride (PVC) resin in dry, powdered form, which additionally contains a heat stabilizer. Examples of such preferred resins are those stabilized with a butyltin thermal stabilizer and having a particle size of about 125 microns and an inherent viscosity of either about 0.52 or about 0.92. Oxyvinyls Inc., Niagara, N.Y., USA, manufactures such polymers, for example.

The particulate polymer is generally added to the white water in an amount ranging from about 20 to about 90 percent by weight of the total solids (based on the combined dry weight of the weight of fibers and polymer).

Any suitable additive recognized as useful for contributing desired physical, chemical or mechanical properties to the fibrous compound or mat, or to the composites formed therefrom, may be included in the white water. Examples of additives that may be added to the white water include dispersants, surfactants such as amine oxides, polyethoxylated derivatives of amide condensation products of fatty acids and polyethylene polyamines, antioxidants, antifoaming agents, foaming agents, bactericides, radiation absorbers, thickeners, softeners, hardeners, UV stabilizers or colorants, such as pigments or dyes. If the layer is an overlay, it may include wear additives, such as described above, which can be added to the white water or later in the process.

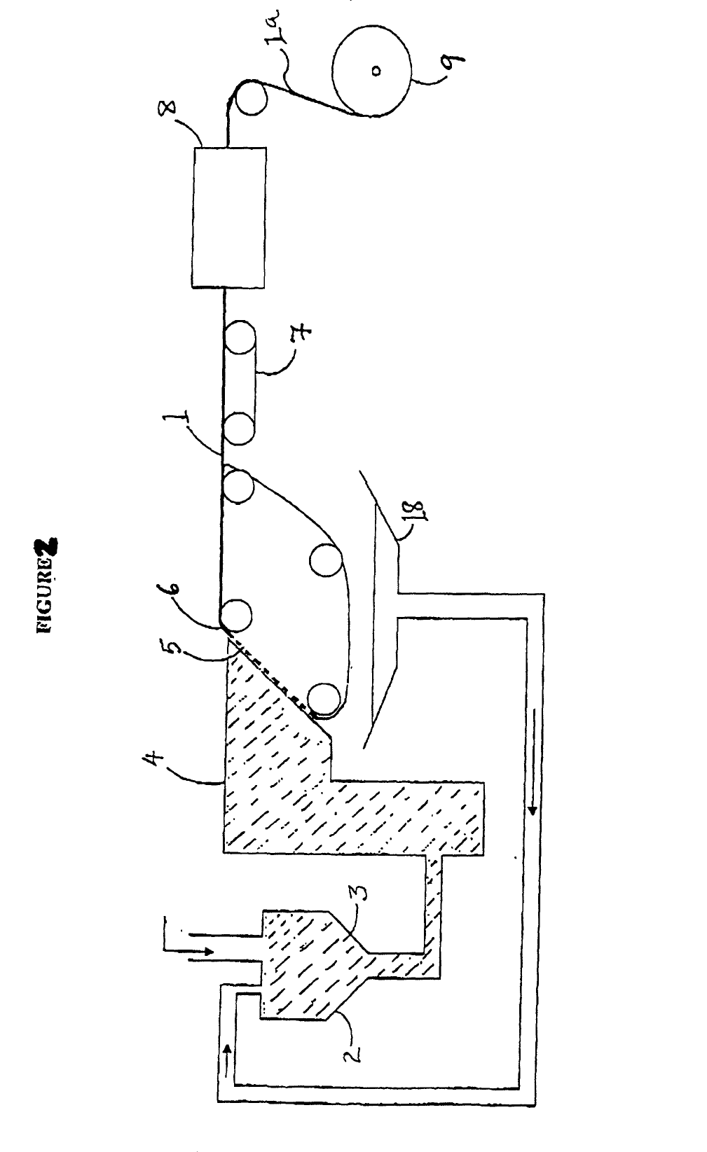

Exemplary processes for preparing fiber reinforced polymer layers useful in the laminate of the invention are described in U.S. Pat. No. 6,093,359, and U.S. application Ser. No. 09/596,065 filed Jun. 16, 2000, both incorporated by reference herein. An exemplary process is now described with reference to FIG. 2.

As shown in FIG. 2, wet or dry chopped reinforcing fibers, preferably glass, are combined with water in a mixing tank 2 and agitated. The particulate polymer is added to the mixing tank 2 with the chopped fibers or after beginning agitation of the fiber-water mixture. The resulting combined aqueous suspension, which is usually referred to as a white water slurry 3, may then be processed into a wet-laid, sheet-like compound using conventionally known equipment such as cylinder or Fourdinier machines, or other machinery such as the Stevens Former, Roto Former, Inver Former, inclined Delta Former and the VertiFormer machines. According to FIG. 2, the white water slurry 3, after it leaves the mixing tank 2, is pumped into a headbox 4, from which it is allowed to flow onto a porous moving screen 6 that is over a series of regularly spaced supports 5. The moving screen 6 transports deposited material from the white water slurry 3 away from the headbox 4 and towards a suitable conveyer apparatus 7, which maintains the movement of the formed product throughout the continuous system. It should be noted that, where the manufacture of the wet-laid compound is not performed as a continuous operation, the moving screen 6 or any other porous surface used need not be combined with a moving belt, rather individual batches of white water slurry 3 may be poured through an immobilized screen (not shown).

Referring again to FIG. 2, as the white water slurry 3 is deposited on the surface of the moving screen 6, excess water is drained through the porous moving screen 6. The porosity of the surface allows the aqueous component of the white water slurry 3, which is predominantly water, to seep through the pores of the moving screen 6, thereby providing for dewatering of the white water slurry 3 as it is carried over the surface of the moving screen 6. The dewatering process may be aided by applying a vacuum suction from any conventional vacuum source (not shown) to the undersurface of the screen or porous surface that exerts sufficient vacuum to remove moisture from the white water slurry 3 as it is transported along the moving screen 6. The slurry is thereby dewatered sufficiently to form a compacted, sheet-like compound 1. At this point the compound may be removed and diverted to a molding operation, or it may be further processed by drying to form an unconsolidated mat.

To form the mat, the compound 1 is moved onto a conveyor belt 7, which may be a moving belt or other device conventionally used for moving a continuously formed product in a sheet-like configuration. Preferably the conveyor belt 7 is a moving belt that is in continuous flow communication with the dewatering apparatus on the input side, and with the post-treatment equipment such as driers, ovens, winders or the like on the output side. Such apparatus may be linked to the other equipment in a continuous system in order to control the rate of movement of the materials through each stage of the process, and thereby control the rate of formation of the product, as well as characteristics of the product, such as thickness of the mat. In the embodiment represented by FIG. 2, the conveyor belt 7 receives the wet-laid compound 1, and transports it into a drier apparatus 8. In this regard, the mat is dried either by air-drying or by exposure to heat. The drier apparatus is preferably an oven, which is set at a temperature high enough to permit fusion of the polymer particles to the filaments of the reinforcement material. For example, the mat may be passed through one or more ovens in a series if the mat is produced in a continuous process, or it may be exposed to a fixed temperature in a single oven for a period of time sufficient to reduce the moisture level to the desired content.

The wet laid compound is dried and fused by removing water by evaporation from the wet laid mat and heating the particles of polymer (e.g. PVC) the reinforcement (e.g. chopped glass strands) to sufficient temperature to cause the PVC particle to adhere to the glass fibers when both are cooled.

An added effect of heating the compound 2 is to accomplish further moisture removal to form a substantially dry mat 1a. The term “substantially dry”, as used herein, means that sufficient water has been removed from the mat to provide a moisture content that is about 2% by weight or less, based on the weight of dry mat. Preferably, the moisture content of the dry mat is less than about 1% by weight, based on the weight of dry mat. Where an oven is used, however, the operating temperature should not be so high as to cause deterioration of the particulate thermoplastic polymer component of the mat, which would affect the heat history of the polymer and result in its reduced physical performance during the molding process. Suitably, the oven temperature is from about 200° C. (392° F.) to about 250° C. (482° F.), preferably from about 215° C. (419° F.) to about 227° C. (441° F.), depending on the basis weight of the product, the line speed, and the shape and the capability of the oven, when the polymer is PVC. The temperature of the compound is monitored by means of thermocouples placed beneath the conveyor belt 7 as it moves through the drier apparatus 8. The rate of movement of the belt is adjusted to permit sufficient exposure at a temperature of from about 171° C. to about 199° C. (340° F. to 390° F.) to achieve fusion of a PVC particulate polymer and the reinforcement. Temperature, time, and pressure conditions could vary depending on the type of polymer used.

The dried mat 1a, after exiting the drier apparatus 8, is then wound, via a puller means (not shown), into packages 9 for storage or shipment. Where a puller means is used, such an apparatus may be used to control the rate of movement of the product during the dewatering and drying stages of the manufacturing operation, as is achieved by the conveyor belt 7.

Additionally, other processing steps may optionally be included in the mat-forming process. For example, a colorant, such as a dye or pigment, in addition to be optionally added in the white-water, can be added in a separate step, for example, above 7 by use of an applicator, such as a binder applicator.

Also, it may be desirable to further process the mat 1a, such as by densifying it, before it is moved through the drier apparatus. The step of densifying can be performed by pressing it with a flat press or by sending it through calendaring rolls (not shown). Densification after drying of the mat 1a is particularly useful for increasing the tensile strength of the mat. Another optional step is to apply materials or ingredients onto the surface of the dewatered compound before, during, or after drying. For example, additives such as pigments or surface active materials may be applied to the dewatered compound I as it is moved along the conveyor belt 7, thereby permitting impregnation of the compound I before it is exposed to the drying process to form the mat 1a. The fiber reinforced polymeric substrate layer may be reinforced with additional PVC or acrylic polymer particles to improve mechanical properties.

The fiber reinforced polymer layers described above, can be used in one or more of the overlay, underlay, or substrate layer, with a decorative layer to form a decorative laminate according to the invention. The layers may be combined in any desired way and in any desired location. One or more of the fiber reinforced polymer layers can be used in the decorative laminate, for example, as both an overlay and underlay, or as two substrate layers

Process of Forming Laminate

The laminates of the invention can be formed by any desired process. One method for forming the decorative laminate is by use of a continuous belt laminator. Suitable machines for performing the continuous process should be capable of rapid throughput under controlled temperature and pressure conditions. Such machines may be selected from a double belt press, roll press, rotocure press, gliding press, roller bed press or fluid or air cushion press. Preferably, a double belt press is used in the continuous manufacturing process. An exemplary laminator is shown in FIG. 3.

As shown in FIG. 3, one or more layers may be integrated to form a composite decorative laminate using a double belt press 20. In this embodiment, one or more layers of dried, wet-laid mat 1a from FIG. 1 may be unwound from rolled stock or input from stacked sections of mat (not shown), thus being combined to form a continuous charge 100. Alternatively, one or more layers of wet-laid mat may be manually layered to form a charge. The charge 100 may comprise one or more decorative layer 101, and optionally other layers, such as one or more release layers 104, wear overlay layer(s) 102, underlay layer(s) 103, and substrate layer(s) 106. 1a may be used as one or more of layers 102, 103, or 106, or not used at all, and another overlay, underlay, and/or substrate used.

Before consolidation, the charge 100 may optionally be passed through one or more pairs of entry rollers 21 for pre-consolidation by applying slight pressure that is sufficient to compress the fiber pack of the charge 100, but not sufficient to break the individual fibers. For example, a pressure of up to about 5 psi or higher may be used. The size of the gap between the entry rollers 21 may, for example, be calibrated to provide sufficient pressure on the charge 100, depending on its thickness, to generate a partially consolidated material that can then be compacted to form a laminate.

The charge 100 is next drawn through a continuous laminator, which is preferably in the form of a double belt press 20. The double belt press 20 is a flat bed press comprised of two endless belts 27, usually made of steel, which run one above the other around two pairs of upper and lower drums 22 and 24 to form a thermally controlled compression zone between them. Within this compression zone, the charge 100 is compressed under heat and elevated temperature to form a laminate. After exiting the entry rollers, the charge 100 is then passed through the thermally controlled compression zone of the double belt press 20. The belts of the double belt press 20 are maintained at a temperature sufficient to heat the layers of the charge to permit fusing and compaction of the reinforcement and particulate polymer, which, in turn eliminates air voids from between the filaments and polymer particles in the wet-laid mat. The initial two drums may be heated.

As the incoming charge 100 is then drawn through the entrance of the thermally controlled compression zone of the double belt press 20, it is seized between the upper and lower belts, and is “sandwiched” between the belts as it moves through the thermally controlled compression zone. The charge 100 is drawn through the machine continuously at constant speed while it is exposed to a fixed pressure, or is drawn through a machine with a constant controlled gap between the belts 27, through which pressure is vertically applied at a 90° angle to the horizontal direction of movement of the charge 100. The amount of pressure applied may vary from about 10 psi to about 450 psi, and is preferably from about 150 psi to about 250 psi. The temperature in the thermally controlled compression zone is generally maintained at a range of from about 320° F. to about 390° F. (about 160° C. to about 199° C.), and is preferably maintained within the range of from about 340° F. to about 370° F. (about 171° C. to about 188° C.). The actual contact time between the heated surfaces in the thermally controlled compression zone is on the order of about 30 to about 300 seconds.

The press zone in between the belts 27 may consist of just one heating zone. It may also be divided into subzones, some subzones are heated under pressure and the others are cooled under pressure. The inlet drums 22 may be heated and the outlet drums 24 may or may not be cooled.

The charge 100 is first heated when passing through the heating subzones, then cooled when passing through the cooling subzones. When the composite laminate 23 so formed exits the double belt press 20; therefore, it is consolidated and cooled. The cooled laminate 23 may then be cut using any suitable cutting means 25 and stacked into sheets 26, or be wound into roll forms.

Optionally before cooling, the laminate 23 may be embossed to provide a decorative or textured surface. The method for embossing may be selected from those conventionally known in the art, such as by passing over textured rolls or stamping. The cooled laminate 23 may then be cut using any suitable cutting means 25 and stacked into sheets 26 or otherwise packaged (not shown) according to the desired application.

The decorative layer can be incorporated into the laminated by a process as described above or adhered to the rest of the laminate in any other desired manner. One advantageous of the invention is that the decorative image can be bonded to the laminate, without destroying the integrity of the print. This is accomplished by limiting flow of resin in the consolidation process, such that the printed image is not disturbed.

Neither adhesive nor solvent is required for the bonding of the decorative layer to the remainder of the laminate, or for the bonding of any of the layers to the laminate. Rather bonding can occurs via laminate consolidation by using a process like a double belt process described above or a batch compression press (not shown), which can be a single cavity, or a multi-cavity press. Bonding may also occur by thermoforming, compression forming, or a combination of both. Bonding without an adhesive is achieved by providing sufficient resin in one of the layers, such as an overlay or underlay, to flow into the other material and act as an adhesive. For example, for a layer of between about 70 to about 90% PVC, the remainder glass fiber can provide sufficient excess resin to allow bonding to one or more adjacent layers. When an adhesive, such as an adhesive coating or film is used, a batch press or a hot melt laminating equipment may be used

In a continuous press, as shown in FIG. 3, pressure, temperature and line speed (residence time) may vary depending on input materials, number of layers of input materials, chemistry of any optional adhesives or chemicals used to treat the layers, and type of laminate. The pressure may be between about 50 psi to about 1000 psi. The pressure is preferably between about 300-500 psi for wood veneer decorative layers, 100-300 psi for polymer-based decorative layers, and 100-400 psi for paper based decorative layers. The heating temperature may be between about 200° F. to about 400° F. The heating temperature is preferably between about 300° F. and 350° F. for wood veneer decorative layers and between about 300° F. to about 400° F. for paper and polymer based decorative layers. Cooling may or may not be required. Press time can be between about 30 to 600 seconds. Press time is a function of thickness of the laminate and also the number of steps used to consolidate the layers.

The double belt press 20 may be equipped with auxiliary edge seals known in the art (not shown) to minimize cross flow and film stretching thus allowing the sample to maintain initial print clarity. When consolidating laminates having narrower width than the belt width, the auxiliary edge seals may keep the top and bottom belt flat and parallel in the cross section, and provide even pressure across the consolidating laminate in cross section.

Heating time in the double belt press 20 should be minimized to minimize flow of the resins. Variables used to control the process include degree of preheating, minimum molding temperature and pressure, line speed, cooling rate; total number of films or laminates relative to the molding temperature of the laminate, and the ability to consolidate with minimum latitudinal and longitudinal flow of material. Pressure should be minimized to minimize print through or telescoping for being visible. Cooling should be sufficient to allow the laminate to exit below the lowest glass transition temperature of the laminate or decorative layer 101.

The method of making the multi-layered laminate having the decorative image may be a one-step process or a two-step process. In the one-step process, the decorative image is bonded to the remainder of the laminate at the same time the layers are being consolidated. See, for example, FIG. 3. In the two-step process, the decorative image is bonded to the laminate after consolidation of one or more of the other layers. Consolidation, as understood in the art, is removal of air from an unconsolidated mat by application of heat or pressure, to thereby form a consolidated sheet. This bonding can be achieved with or without the use of an adhesive.

A hydraulic press (not shown) may also be used to form the decorative laminate. The hydraulic press may be a one-step process or two-step process. In a one-step process, a consolidated or unconsolidated polymeric layer can be used as input material. The process cycle includes both heating and cooling the materials under pressure. Typically the platen temperature may range from about 300° F. to about 400° F., preferably between about 340° F. to about 390° F. Too low a temperature will not melt the polymer of the layers, for example, PVC and/or acrylic and too high a temperature may degrade it. Pressure may vary from about 75 psi to about 600 psi, preferably about 150 psi to about 350 psi, and more preferably about 175 psi to about 300 psi. Heating time may vary from about 1 to 10 minutes depending on the thickness of the laminate and the platen temperature, preferably from about 1 to 3 minutes. The cooling time is dependent on the thickness of the laminate and the design of the press. Typically the laminate can be demolded upon being cooled down to about 200° F. to about 260° F. Not enough cooling may result in material deconsolidation and over cooling will prolong the cycle time and results in economic penalty. An adhesive is not needed because the polymer, e.g. PVC, of the underlay or overlay, serves to bind the decorative layer 101 by melting and solidifying.

In a two-step process, consolidated composite is generally used as input material. The process involves heating under pressure. Cooling is not required, however an adhesive layer is generally used. The typical process parameters will depend on the type of adhesive used and the thickness of the laminate. For example, when a hotmelt polyurethane is used as adhesive, the platen temperature may vary from about 150° F. to about 250° F., preferably from about 190° F. to about 220° F. Pressure may vary from about 10 psi to about 200 psi, preferably about 30 psi to about 100 psi; and the press time may vary from about 30 to 300 seconds, preferably about 60 to 150 seconds.

The decorative layer may stretch during the bonding process if the temperature and pressure is not properly controlled, which results in undesired distortion of the decorative image. Molding of laminates containing a decorative layer requires consideration of how any flow in the molding process will affect the fidelity or registry of the print layer. Pressures and temperatures should be controlled to minimize flow while creating a well-laminated part. Typically for a laminate comprising a fiber reinforced polymeric layer and a decorative layer, fidelity is maintained when molding pressures are between about 150 psi to about 200 psi at temperatures between about 340° F. to about 370° F.

During the consolidation process, the layer(s) to which the decorative layer 101 will be bonded may be preheated. Preheating the charge minimizes the time required to heat the charge to consolidation temperatures. The charge may be a fixed combination of resin and reinforcement that is formed prior to the consolidation process such that no other resin or reinforcement must be added to complete the laminate when heat and pressure are applied. A fiber reinforced polymeric layer as underlay, overlay, and/or substrate is a preferred charge.

Preheating may also minimize the period of time that the decorative layer 101 is exposed to high temperatures, which may distort the decorative image. The decorative layer 101 may be cooled during the molding process in order to prevent distortion of the decorative image.

Release paper 104 may be used to prevent adhesion of the laminate to the bonding and molding equipment. The release paper may also be used to emboss the laminate or give the laminate a texture or to provide desired gloss. Any release paper that provides the desired function can be used. For example, the release paper can be a chemically treated paper that prevents the materials from sticking to the press. Commercially available release papers can be obtained from S. D. Warren Company, Westchester, Ill., or Ivex Packaging Corporation, Troy, Ohio, or Ahistrom, Bousbecque, France, etc. Other release medium, such as Teflon coated glass fabric, may also be used. The release paper is generally removed from the final product.

When an adhesive is used to bond or more layers of the laminate, then it can be in film form or liquid form. When in the film form, the adhesive can be simply layered in-between the adjacent layers and then pressed together. When in the liquid form, the adhesive can be first coated on one layer and then the adjacent layer is pressed together therewith. The liquid adhesive can be coated on via a roll coater, a spread gun, or the like. Preferred adhesives include hot-melt polyurethane adhesives and epoxy adhesive.

The processing parameters may vary depending on the chemistry of the optional adhesives and the thickness of the laminate. For example, when a hot-melt polyurethane is used as adhesive, the platen temperature may vary from about 150° F. to about 250° F., preferably from about 190° F. to about 220° F. Pressure may vary from about 10 psi to about 200 psi, preferably from about 30 psi to about 100 psi; and the press time may very from 30 to 300 seconds, preferably 60 to 150 seconds.

The laminate can also be formed by compression molding to form a compression molded part.

Some decorative laminates formed according to the present invention provide certain improvements over laminates formed from wet-laid, binder-added mat formed according to the prior art. Such improvements include increased rigidity and impact resistance of the laminate product, as well as increased fiber length retention in the finished product. In particular, a continuous molding process such as the double belt laminating process, when utilized to process laminates using a fiber reinforced polymeric layer, results in increased retention of fiber length when the fiber reinforced polymeric layer is subjected to a un-preheated single-cavity or multi-cavity molding process. In such a process, the improvement in retained average fiber length may be about 1.5× or higher. As a result of this improvement, mechanical properties of the resulting laminates, such as tensile strength, impact resistance, and HDT are enhanced over equivalent reinforced laminates flexural modulus and coefficient of thermal expansion are enhanced. In addition, the proportion of reinforcing fiber material may also affect these properties.

The laminates of the invention, such as those comprising a reinforced PVC underlay or overlay, provides improved fire resistance and the ability to print directly on the PVC layer or add other layers. Both printability and fire resistance are often not possible with other types of polymers, such as polypropylene.

The present decorative laminates that include a reinforced polymer layer as overlay, underlay and/or substrate, compared to conventional decorative materials, such as those based on paper and phenolic backers, can have improved strength, flexibility, moisture resistance, fire resistance, printability, and impact resistance. The decorative laminates can also provide unique properties of higher moisture resistance, higher modulus, lower coefficient of linear theremal expansion (CLTE), and better dimensional stability. It also helps maintain wood grain when used in profile rapping or edge bending, and the like. The laminates also are useful in automobile interiors, such as wood-trim, desk-tops, and wall covering.

Fire-Retardant Laminates

The invention also provides a laminate of improved fire resistance that includes a fiber-reinforced polymeric layer and a fiber reinforced polypropylene layer. The fiber reinforced polymeric layer is preferably a PVC glass mat with optional colorants that can be made as described above. The polypropylene layer is preferably a polypropylene-glass composite. The laminates of this embodiment have improved flame retardance over other polypropylene fiber reinforced laminates, and hence are especially useful in applications requiring high flame retardance, such as cargo bins and truck liners.

To maximize flame retardance, it is preferred that a PVC-glass layer fully envelope the polypropylene layer, since polypropylene readily burns. Thus, a layer of the PVC can be on both sides of the polypropylene. An additional layer can be outside one or both of the PVC layers, such as a decorative layer as described above. The PVC layer imparts a smooth, bondable surface for decorative purposes. The low coefficient of thermal expansion and low shrinkage of PVC-long glass materials offers significant surface advantages over polypropylene-glass composites.

This embodiment offers an inexpensive solution for providing a decorative, structural, flame-retardant, surface to polypropylene-glass composite materials. Processing cost can be minimized by laminating or molding PVC-glass external layers around a PP-glass composite core during the final shaping operation.

It was surprising to find that the PVC and polypropylene layers would bind to each other without requiring an adhesive. Bonding is surprisingly achieved by a fiber/resin mechanical interlocking mechanism that occurs between the two thermoplastic, glass fiber composite materials. Without the mechanical bonding interaction, it would be likely be need to employ surface energy enhancement techniques such as flame treatment, Corona Discharge, plasma treatments, or other primer techniques along with various adhesives or tie layers to effectively bond polypropylene (PP) glass composites to an external decorative or flame retardant surface. The efficient mechanical bonding observed between PVC composite and PP composite materials makes it possible to economically process both materials during a single processing step. The external PVC-glass composite layer provides for a flame retardant, structural, and decorative surface. Preferably the fibers of the PVC are long glass fibers as discussed below.

The laminates can be formed as described above with reference to the decorative layers. The PVC layer can be formed as describe above. Any desired reinforced PP can be used. These laminates combine the structural, bondable, and decorative characteristics of PVC-long glass fiber, i.e. initial glass fiber lengths greater than or equal to 0.5″, composites with the economics and impact performance of a commingled polypropylene/glass woven composite system. By combining both composite materials together under, for example, temperatures ranging from about 360-390° F. and pressures ranging from about 50-200 psi, there are formed mechanically, interlocked PVC-glass/PP-glass/PVC-glass or PVC-glass/PP-glass sandwich structures that can withstand the rigors of vast temperature and humidity changes. Processing temperatures should generally reside below about 400° F. to avoid PVC degradation and remain above the melting temperature of the polypropylene resin. Pressures should be great enough to consolidate the two materials, but not be excessive to cause the polypropylene-glass composite to flow past the PVC-glass composite boundary.

It is best to undersize the PP-glass composite structure to better encapsulate this material within the PVC-glass external material. The molecular weight of the polypropylene material can be optimized to provide sufficient flow behavior at the desired processing range combined with reasonable matrix property benefits. Glass contents in the polypropylene materials typically will fall somewhere between about 38 to about 42% by weight, while the glass content in the PVC-glass composite materials will typically reside between about 17 to about 25% by weight. Greater glass contents in the PVC long glass composite material may result in poorer bondability and surface appearance, whereas glass contents in the polypropylene composite are set to achieve reasonable flow characteristics combined with good mechanical performance.

The fire-retardant laminates can be formed as described above with reference to the decorative laminate. The PVC layer can be formed as described above. Any desired reinforced PP can be used. A preferred reinforced PP is Azdel®, available from Azdel Inc., Shelby, N.C.

The laminate can also be made by compression molding the reinforced polypropylene layer and a fiber-reinforced (e.g., PVC layer). Such compression molded parts are useful, for example, as automobile parts (seat-backs, doors, instrument panes and the like) and in appliances such as washing machine lids.

The following examples are illustrative of the invention, but do not limit the scope of this invention.

### EXAMPLES

### Example 1

### Composite Backed Wood Veneer—Hydraulic Press—One Step Process

A charge was assembled, starting with one ply release paper from bottom, followed by one ply mat (of unconsolidated fiberglass/PVC compound), one ply Red Oak wood veneer (about 0.020″ in thickness, supplied by Universal Veneers, Newark, Ohio), and another ply release paper on top.

A hydraulic press with both heating and cooling capabilities was used in the experiment. The press platens were first preheated and stabilized at 345° F. Then, the charge was fed into the press. The press was immediately closed and pressure was raised to 400 psi. The charge was heated under the pressure for 45 seconds, then, cooled down to about 230° F. under pressure, and then, discharged from the press. The discharged assembly was further cooled on a table top before removing the reusable release papers.

In this example, both consolidation and adhesion were accomplished in one step without using any adhesives. No overheating occurred on veneer.

### Example 2

### Wood Veneer with a Wear Overlay—Hydraulic Press—One Step Process

Same as Example 1 except how the charge was assembled. In this example, the charge was prepared, starting with one ply release paper from bottom, followed by one ply Red Oak wood veneer, one ply mat (of unconsolidated, fully dispersed fiberglass/PVC compound, as a wear resistant overlay), and another ply release paper on top.

Both consolidation and adhesion were accomplished in one step without using any adhesives. The overlay was nearly transparent causing very limited changes in the appearance of the wood veneer.

### Example 3

### Wood Veneer with Both Overlay and Underlay Layer—Hydraulic Press-One Step Process

A charge was assembled, starting with one ply release paper from bottom, followed by one ply mat (of unconsolidated fiberglass/PVC compound), one ply reconstituted wood, one ply mat (of unconsolidated fully dispersed fiberglass/PVC compound as an overlay), and another ply release paper on top.

The process parameters were the same as in Example 1.

The overlay was nearly clear causing very limited changes in the appearance of the reconstituted wood veneer.

### Example 4

### Paper-Based Decorative Laminate—Hydraulic Press—One Step Process

A charge was assembled, starting with one ply release paper from bottom, followed by one ply mat (unconsolidated fiberglass/PVC compound as a substrate), one ply mat(unconsolidated, fully dispersed fiberglass/PVC compound as an underlay), one ply printed paper (supplied by Toppan), one ply mat (unconsolidated, fully dispersed fiberglass/PVC compound as a wear overlay), and another ply release paper on top.

A hydraulic press with both heating and cooling capabilities was used in the experiment. The press platens were first preheated and stabilized at 370° F. Then, the charge was fed into the press. The press was immediately closed and pressure was raised to 300 psi. The charge was heated under the pressure for 80 seconds, then, cooled down to about 240 F. under pressure, then, discharged from the press. The discharged assembly was further cooled on table top before the release papers were recovered and reused.

In this example, both consolidation and adhesion were accomplished in one step without using any adhesives. The printed paper maintained fidelity. The overlay was nearly clear causing very limited changes in the appearance of the printed paper.

### Example 5

### Paper-Based Decorative Laminate—Hydraulic Press—One Step Process

Same as Example 4 except the temperature was 390° F. and the heating cycle was 60 seconds.

The results were approximately the same as in Example 4.

### Example 6

### Polymer-Based Decorative Laminate—Hydraulic Press—One Step Process

Same as Example 4 except (1) using one ply printed PVC film (supplied by Toppan) to replace the printed paper and (2) the press pressure was set at 200 psi instead of 300 psi.

The results were approximately the same as in Example 4. Almost no flow on the PVC film was observed.

### Example 7

### Polymer-Based Decorative Laminate—Hydraulic Press—One Step Process

Same as Example 6 except the overlay layer was replaced with one layer of Korad® film and one layer of 30 grams/square meter wet laid glass veil (obtained from Owens Corning, OC52430A). The results were similar to that in Example 6.

### Example 8

### Polymer-Based Decorative Laminate—Hydraulic Press—One Step Process

Same as Example 6 except the underlay layer was replaced with one layer of PVC film and one layer of 30 grams/square meter wet laid glass veil (obtained from Owens Corning, OC52430A). The results were similar to that in Example 6.

### Example 9

### Polymer-Based Decorative Laminate—Hydraulic Press—One Step Process

Same as Example 6 except the substrate layer was not used.

The results were similar to that in Example 6.

### Example 10

### Polymer-Based Decorative Laminate—Hydraulic Press—One Step Process

Same as Example 9 except the overlay layer was replaced with a mat of unconsolidated, fully dispersed fiberglass/acrylic compound.

The results were similar to that in Example 9. However, the overlay layer was more clear and transparent than that in Example 9.

### Example 11

### Paper-Based Decorative Laminate—Hydraulic Press—One Step Process

Same as Example 4 except (1) the wear layer was replaced with melamine treated paper as overlay and (2) the heating temperature was 360° F.

In this example, the consolidation of PVC/fiberglass compound, the curing of the melamine, and the adhesion were all accomplished in one step without using any adhesives. The adhesion was good and no damages on the fidelity of printed paper were observed.

### Example 12

### Polymer-Based Decorative Laminate-Hydraulic Press-Two Step Process

In this example, the consolidated fiber glass/PVC sheets were made in the first step and used as input material in the second step.

In the first step, a charge consisting of one ply release paper, 16 ply mat(unconsolidated fiberglass/PVC compound), and another ply of release paper was fed into the press and heated under a pressure of 300 psi at a temperature of 390° F. for 120 seconds. Then, it was cooled down under pressure to 250° F. and discharged from the press. As a result, a sheet of about 0.112″ in thickness was produced.

In the second step, a charge was prepared, starting with one ply release paper from bottom, followed by the sheet made in step one, one ply printed PVC film, and another ply release paper on top.

The press platens were first preheated and stabilized at 290° F. Then, the charge was fed into the press. The press was immediately closed and pressure was raised to 100 psi. The charge was heated under the pressure for 60 seconds, then, discharged from the press without cooling. The discharged assembly was cooled on table top before the release papers were recovered for future use.

The adhesion was good and no distortion was observed on the fidelity of printed PVC film. In this example, no fully dispersed underlay layer was used and some fiber show through was observed.

### Example 13

### Composite Backed Wood Veneer—Hydraulic Press—Two-Step Process

In this example, the consolidated fiber glass/PVC sheets were made in the first step and used as input material in the second step.

In the first step, a charge consisting of 12 ply unconsolidated mats (PVC/fiberglass compound) and 13 ply Teflon® coated fabric (supplied by Tectonic as a release medium) were arranged in the following manner. The charge started with one ply release at bottom and finished with one ply release at top, in between the mat and release were layered alternatively so that the sheet could be separated after consolidation and that both the top and bottom platens were protected by the release medium. The charge was heated under a pressure of 300 psi at a temperature of 390° F. for 150 seconds, then cooled down under pressure to 250° F. and discharged from the press. In this step, 12 consolidated sheets of about 0.007″ in thickness were made in one press opening.

In the second step, a charge was prepared, starting with one ply release paper from bottom, followed by one ply consolidated sheet (made in step one), one ply polyurethane hotmelt adhesive film (supplied by Bemis), one ply Cherry wood veneer (about 0.020″ in thickness, supplied by Cramer Wood Products, High Point, N.C.), and another ply release paper on top.

The press platens were first preheated and stabilized at 220° F. Then, the charge was fed into the press. The press was immediately closed and pressure was raised to 50 psi. The charge was heated under the pressure for 90 seconds, then, discharged from the press without cooling. The discharged assembly was cooled on table top before the release papers were recovered and reused.

The adhesion was good. No overheating on the wood veneer was observed.

### Example 14

### Polymer-Based Decorative Laminate—Hydraulic Press—Two-Step Process

The consolidated 0.007″ thick sheets were made as in Example 13, step one. However, fully dispersed fiberglass/PVC mat was used as the input.

In the second step, a charge were prepared, starting with one ply release paper from bottom, followed by one ply consolidated sheet (made in step one), one ply printed PVC film (Obtained from Toppan), and another ply release paper on top.

The press platens were first preheated to and stabilized at 290° F. Then, the charge was fed into the press. The press was immediately closed and pressure was raised to 60 psi. The charge was heated under the pressure for 60 seconds, then, discharged from the press without cooling. In the second step, a decorative polymer film was laminated to the composite substrate without using any adhesives. The bonding was good.

### Example 15

### Polymer-Based Decorative Laminate—Double Belt Press—One Step Process

Analogous to FIG. 3, a charge (item 100) consisting of one ply release paper, one ply unconsolidated, fully dispersed mat as wear overlay, one ply printed PVC film(obtained from Toppan), one ply unconsolidated, fully dispersed mat as underlay, and another ply release paper was fed into a double belt press and continuously processed at a line speed of 15 feet per minute. A polymer-based decorative laminate was produced after the release papers were peeled off and rewound for reuse at the other end of the line.

The press was preheated and stabilized at preset temperatures. All the input materials and the release medium were in roll form and fed into the press at a same (lineal) speed. In this example, the inlet drums were set at 180° C. (356° F.), the heating zone (both top and bottom) was set at 184° C. (363° F.), and the cooling zone (both top and bottom) was set at 110° C. (230° F.). Both the heating and cooling zones were operated under a uniform pressure of 200 psi. The charge was first heated at the inlet drums, pressurized in the heating zone while being further heated and “melted”, then, cooled down and consolidated under pressure in the cooling zone. Up on exiting the nip of the outlet drums, the release papers were pealed off and rewound for future use, and the decorative laminate was trimmed to 48″ net width, then wound into a roll and packaged.

In this example, consolidation and adhesion were accomplished in one step. The adhesion was good. Almost no distortion on the printed film was observed. The overlay was nearly clear causing very limited changes in the printed polymer film.

### Example 16

### Polymer-Based Decorative Laminate—Double Belt Press—One Step Process

Same as Example 15 except the laminate was cut to 4′×8′ sheets after being trimmed.

### Example 17

### Polymer-Based Decorative Laminate—Double Belt Press—One Step Process

Same as Example 15 except no overlay layer was used.

### Example 18

### Polymer-Based Decorative Laminate—Double Belt Press—One Step Process

Same as Example 15 except no underlay layer was used.

### Example 19

### Paper-Based Decorative Laminates—Double Belt Press—One Step Process

Same as Example 18 except a print paper (obtained from Toppan) was used as the decorative layer to replace the printed PVC film.

### Example 20

### Polymer-Based Decorative Laminate—Double Belt Press—One Step Process

Analagous to FIG. 3, a charge consisting of one ply release paper, one ply printed PVC film (obtained from Toppan), two ply unconsolidated mat as reinforcement substrate, and another ply release paper was fed into a double belt press and continuously processed at a line speed of 14 feet per minute. A polymer-based decorative laminate was produced after the release papers were peeled off and rewound for reuse at the other end of the line.

The press was preheated and stabilized at preset temperatures. All the input materials and the release medium were in roll form and fed into the press at a same (lineal) speed. In this example, the inlet drums were set at 180° C. (356° F.), the heating zone (both top and bottom) was set at 186° C. (367° F.), and the cooling zone (both top and bottom) was set at 110° C. (230° F.). Both the heating and cooling zones were operated under a uniform pressure of 300 psi. The charge was first heated at the inlet drums, pressurized in the heating zone while being further heated and “melted”, then, cooled down and consolidated under pressure in the cooling zone. Up on exiting the nip of the outlet drums, the release papers were pealed off and rewound for future use, and the decorative laminate was trimmed to 48″ net width, then cut to 4′×8′ sheets, put on a pallet and packaged.

No fully dispersed underlay layer was used in this example and some fiber show through was observed.

### Example 21

### Composite Backed Wood Veneer—Double Belt Press—One Step Process

Analogous to FIG. 3, a charge consisting of one ply release paper, one ply cherry wood veneer (obtained from Cramer Wood Products), one ply unconsolidated mat as a backer, and another ply release paper was fed into a double belt press and continuously processed at a line speed of 15 feet per minute. A polymer composite backed wood veneer was produced after the release papers were peeled off and rewound for reuse at the other end of the line.

The press was preheated and stabilized at preset temperatures. In this example, the mat and the release medium were in roll form and fed into the press at a same (lineal) speed. The wood veneers were in 4′×8′ sheets and fed into the press piece by piece. The inlet drums were set at 160° C. (320° F.), the heating zone (both top and bottom) was set at 173° C. (343° F.), and the cooling zone (both top and bottom) was set at 110° C. (230° F.). Both the heating and cooling zones were operated under a uniform pressure of 450 psi. The charge was first heated at the inlet drums, pressurized in the heating zone while being further heated and “melted”, then, cooled down and consolidated under pressure in the cooling zone. Up on exiting the nip of the outlet drums, the release papers were pealed off and rewound for future use, and the Composite backed wood veneer was cut to 4′×8′ sheets and packaged.

### Example 22

### Decorative Laminate Over Twintex® Substrate—Hydraulic Press—One Step Process

A charge was assembled, starting with one ply release paper from bottom, followed by one ply commingled, woven polypropylene glass (Twintex)®, one ply mat(unconsolidated, fully dispersed fiberglass/PVC compound as an underlay), one ply printed PVC, and another ply release paper on top.

A hydraulic press with both heating and cooling capabilities was used in the experiment. The press platens were first preheated and stabilized at 370° F. Then, the charge was fed into the press. The press was immediately closed and the charge was heated at a kiss pressure for 10 seconds. After this step, the pressure was raised to 100 psi, and the charge was heated under the pressure for 45 seconds to promote interlayer bonding, then, cooled down to about 230 F. under pressure, then, discharged from the press. The discharged assembly was further cooled on table top before the release papers were recovered and reused.

In this example, the consolidation of PVC and of polypropylene and the adhesion were accomplished in one step without using any adhesives. Photographs of the bonding region revealed a mechanical interlocking effect which held both materials together under vast changes in temperature and humidity conditions.

### Example 23

### Laminate of Reinforced PVC and Polypropylene—Hydraulic Press—One Step Process

Same as Example 22 except the printed PVC layer was not used.

### Example 24

### Overlaid Decorative Laminate Over Twintex Substrate—Hydraulic Press—One Step Process

A charge was assembled, starting with one ply release paper from bottom, followed by one ply commingled, woven polypropylene glass (Twintex)®, one ply mat(unconsolidated, fully dispersed fiberglass/PVC compound as an underlay), one ply printed PVC, one ply mat (of unconsolidated, fully dispersed fiberglass/PVC compound as a wear resistant overlay), and another ply release paper on top.

A hydraulic press with both heating and cooling capabilities was used in the experiment. The press platens were first preheated to and stabilized at 370° F. Then, the charge was fed into the press. The press was immediately closed and the charge was heated at a kiss pressure for 10 seconds. After this step, the pressure was raised to 200 psi, and the charge was heated under the pressure for 45 seconds to promote interlayer bonding, cooled down to about 230° F. under pressure, and then discharged from the press. The discharged assembly was further cooled on table top before the release papers were recovered and reused.

In this example, the consolidation of PVC and of polypropylene and the adhesion were accomplished in one step without using any adhesives. Photographs of the bonding region revealed a mechanical interlocking effect which held both materials under vast changes in temperature and humidity conditions.

The raw materials and process summary for the examples are shown in Tables 1 and 2 that follow.

It is believed that applicants' invention includes many other embodiments which are not herein specifically described, accordingly this disclosure should not be read as being limited to the foregoing examples or preferred embodiments.

The raw materials and process summary of the examples is show in Tables 1 and 2.

TABLE 1

| | Material | | |
|---|---|---|---|
| Raw Materials | ID | Description | Manufacturer |
| Overlay mat | a | unconsolidated, fully | Decillion, LLC, |
| | | dispersed fiberglass/ | Toledo, Ohio |
| | | PVC compound, basis | |
| | | weight = 0.06 pounds/ | |
| | | ft2, K1/2″ fiberglass, | |
| | | glass content = 20% | |
| Overlay mat | aa | Unconsolidated, fully | Decillion, LLC, |
| | | dispersed fiberglass/ | Toledo, Ohio |
| | | acrylic compound, | |
| | | basis weight = 0.06 | |
| | | pounds/ft2, K1/2″ | |
| | | fiberglass, glass | |
| | | content = 20% | |
| Underlay mat | b | unconsolidated, fully | Decillion, LLC, |
| | | dispersed fiberglass/ | Toledo, Ohio |
| | | PVC compound, basis | |
| | | weight = 0.06 pounds/ | |
| | | ft2, K3/4″ fiberglass, | |
| | | glass content = 20% | |
| Substrate mat | c | unconsolidated, fiber- | Decillion, LLC, |
| | | glass/PVC compound, | Toledo, Ohio |
| | | basis weight = 0.06 | |
| | | pounds/ft2, M 1.25″ | |
| | | fiberglass, glass | |
| | | content = 30% | |
| Printed paper-1 | d | printed paper, dry, no | Toppan |
| | | melamine, no coating | International, |
| | | | McDonough, GA |
| Printed paper-2 | e | printed paper, dry, no | Toppan |
| | | melamine, no coating, | International, |
| | | different image from | McDonough, GA |
| | | “printed paper-1” | |
| Printed PVC film | f | Printed polyvinyl | Toppan |
| | | chloride film | International, |
| | | | McDonough, GA |
| Printed PVC film | g | printed polyvinyl | Toppan |
| | | chloride film with | International, |
| | | acrylic coating | McDonough, GA |
| Korad ® Film | h | Clear acrylic film, | Polymer Extruded |
| | | about 0.003″ thick | Product, |
| | | | Newark, NJ |
| Glass veil | k | An wet laid fiberglass | Owens Corning, |
| | | veil with an acrylic | Toledo, Ohio |
| | | binder, 30 g/m2 | |
| Twintex | l | A commingled, woven | Vetrotex, |
| | | fiberglass poly- | Valley Forge, PA |
| | | propylene composite | |
| Overlay paper | m | Aluminum oxide | Casco Impregnated |
| | | impregnated, | Papers Com, |
| | | melamine treated | Blythecwood, SC |
| | | paper | |
| Clear PVC film | n | Clear PVC film, no | O'Sullivan Corp, |
| | | printing image | Winchester, VA |
| Wood veneer-1 | o | Red Oak wood veneer | Universal Veneer, |
| | | about 0.020″ thick | Newark, OH |
| wood veneer-2 | p | Cherry wood veneer | Cramer Wood |
| | | about 0.020″ thick | Products, |
| | | | High Point, NC |
| Wood veneer-3 | q | Reconstituted wood | IpirAmerica, |
| | | veneer about 0.020″ | Katy, TX |
| | | thick | |
| Adhesive film | r | polyurethane-based | Bemis |
| | | hotmelt adhesive film | Associates Inc, |
| | | about 0.003″ thick | Shirley, MA |
| Release paper | s | Chemically coated | S. D. Warren Com., |
| | | paper as a release | Westchester, IL |
| | | medium | |
| Teflon ®/ | t | Teflon coated woven | Taconic, |
| glass cloth | | fiberglass fabric as a | Petersburgh, NY |
| | | release medium | |

| | | Process | | |
|---|---|---|---|---|
| | Raw Materials Used | Batch vs. | | Release |
| Example | (See Table 1 for I.D) | Continuous | Steps | Medium |
| 1 | o, c | Batch | One | s |
| 2 | a, o | Batch | One | s |
| 3 | a, q, c | Batch | One | s |
| 4 | a, d, b, c | Batch | One | s |
| 5 | a, d, b, c | Batch | One | s |
| 6 | a, f, b, c | Batch | One | s |
| 7 | h, k, f, b, c | Batch | One | s |
| 8 | a, f, n, k, c | Batch | One | s |
| 9 | a, f, b | Batch | One | s |
| 10 | aa, f, b | Batch | One | s |
| 11 | m, d, b, c | Batch | One | s |
| 12 | f, c | Batch | Two | s |
| 13 | p, r, c | Batch | Two | s, t |
| 14 | g, b | Batch | Two | s, t |
| 15 | a, g, b | Continuous | One | s |
| 16 | a, g, b | Continuous | One | s |
| 17 | g, b | Continuous | One | s |
| 18 | a, g | Continuous | One | s |
| 19 | a, e | Continuous | One | s |
| 20 | f, c | Continuous | One | s |
| 21 | p, b | Continuous | One | s |
| 22 | g, b, l | Batch | One | s |
| 23 | b, l | Batch | One | s |
| 24 | a, g, b, l | Batch | One | s |

We claim:

1. A decorative laminate comprising
a) an optional overlay comprised of a reinforced polymeric layer formed by preparing a non-woven, fibrous, fully dispersed, wet-laid compound by mixing a suspension comprising a reinforcement material, at least one particulate thermoplastic polymer, and optional additives for imparting additional wear resistance to the laminate, in an aqueous medium to form a white water slurry, dewatering the white water slurry to form a wet-laid compound impregnated with the particulate thermoplastic polymer, and drying and fusing the wet-laid compound to form a fiber-reinforced polymer layer,
b) a decorative layer,
c) an optional underlay optionally containing a colorant formed by preparing a non-woven, fibrous, fully or non-fully dispersed, wet-laid compound by mixing a suspension comprising a reinforcement material, at least one particulate thermoplastic polymer in an aqueous medium to form a white water slurry, dewatering the white water slurry to form a wet-laid compound impregnated with the particulate thermoplastic polymer, and drying and fusing the wet-laid compound to form a fiber-reinforced polymer layer, and
d) an optional substrate layer,
with the proviso that at least one layer of a) or c) is present.

2. A decorative laminate according to claim 1, wherein the decorative layer (b) comprises a carrier film and a layer of ink.

3. A decorative laminate according to claim 2, wherein the ink is thermal and UV stable.

4. A decorative laminate according to claim 2, wherein the carrier film comprises polyvinyl chloride.

5. A decorative layer according to claim 4, where the polyvinyl chloride film has plasticizer at less than about 20 parts per hundred.

6. A decorative laminate according to claim 2, further comprising a UV protective layer on the ink layer.

7. A decorative laminate according to claim 6, wherein the protective layer comprises an acrylic layer.

8. A decorative laminate according to claim 1, wherein decorative layer (b) comprises a reverse printed film.

9. A decorative laminated according to claim 1, wherein decorative layer (b) comprises a printed paper layer.

10. A decorative laminate according to claim 1, wherein decorative layer (b) comprises a wood-grain image, wood veneer, or reconstituted wood veneer.

11. A decorative laminate according to claim 1, wherein overlay (a) is present and adjacent to decorative layer (b), and no adhesive is included there between.

12. A decorative laminate according to claim 1 wherein underlay (c) is present and adjacent to decorative layer (b) and no adhesive is included there between.

13. A decorative laminate according to claim 1, wherein overlay (a) is present and comprises a fully consolidated laminate, which is bonded to decorative layer (b) with an adhesive.

14. A decorative laminate according to claim 1, wherein underlay (c) is present and comprises a partially or fully consolidated laminate which is bonded to decorative layer (b) with an adhesive.

15. A decorative laminate according to claim 1, comprising an overlay (a) and underlay (c), which are both adjacent to decorative layer (b) wherein there is no adhesive between (a) and (b) or (c) and (b).

16. A decorative laminate according to claim 1, wherein overlay (a) is present and comprises a fully consolidated laminate, and underlay (c) is present and comprises a partially or fully consolidated laminate, and where (a) and (c) are independently adhered to decorative layer (b) with an adhesive.

17. A decorative laminate according to claim 12, wherein layer (b) comprises wood veneer or reconstituted wood veneer.

18. A decorative laminate according to claim 1, wherein overlay (a) is present and comprises glass fiber-reinforced polyvinyl chloride with substantially no optional wear-resistance additives.

19. A decorative laminate according to claim 18, wherein the reinforcement in layer (a) comprises fully dispersed wet used chopped strand glass fibers having a fiber diameter from about 11 to about 17 microns, and a fiber length of about 10 to about 18 millimeters.

20. A decorative laminate according to claim 19, where the wet used chopped strand glass fibers have a diameter of about 13 microns and a length of about 12.5 millimeters.

21. A decorative laminate according to claim 1, wherein overlay (a) is present and comprises glass fiber reinforced polyvinyl chloride with one or more additives to improve wear resistance of the laminate and reduce moisture permeability while maintaining transparency.

22. A decorative laminate according to claim 21, wherein the additives are selected from the group consisting of glass beads, flake glass, and wet used chopped strand glass fibers having a length of less than about 0.25″ and a diameter of less than about 11 microns.

23. A decorative laminate according to claim 22, wherein the additive comprises wet used chopped strand glass fibers having a diameter of about 7 microns and a length of about 0.125 inches.

24. A decorative laminate according to claim 21, wherein the total weight percent of reinforcement plus additives in layer (a) is between about 20 and about 28% by weight of the total weight of layer (a).

25. A decorative laminate according to claim 1, comprising a substrate (d) and an underlay layer (c) which reduces the likelihood of defects in the substrate layer (d) from telescoping to the decorative layer (b).

26. A decorative laminate according to claim 1, wherein the substrate layer (d) is present and is selected from metal, particle board, Medium Density Fiberboard, plywood, engineered wood panel, oriented stand board, wheatboard, strawboard, reconstituted cellulosic panels, polymeric foams, honeycomb structural panels, mineral filled polymer, concrete, or an unreinforced or reinforced polymeric layer.

27. A decorative laminate according to claim 26, wherein the substrate layer (d) comprises a reinforced polymeric layer.

28. A decorative laminate according to claim 26, wherein the substrate layer (d) comprises a reinforced polypropylene layer.

29. A decorative laminate according to claim 1, wherein layer (c) is present and comprises fully dispersed wet used chopped strand glass fibers having a fiber diameter from about 11 to about 17 microns, and a fiber length of about 10 to about 18 millimeters.

30. A decorative laminate according to claim 29, wherein the wet used chopped strand glass fibers have a diameter of about 13 microns and a length of about 17 millimeters.

31. A decorative laminate according to claim 1, which is formed by:
i) forming a charge comprising at least said overlay (a) or underlay (c) and at least one decorative layer (b); and
ii) heating and applying pressure to cause the polymer of layer (a) or layer (c) to flow and form a decorative laminate.

32. A decorative laminate according to claim 1, wherein the overlay (a) is present comprises a glass veil and a polymer layer opposite the decorative layer (b).

33. A decorative laminate according to claim 32, wherein the glass veil comprises wet laid glass fibers and a polymeric binder.

34. A decorative laminate according to claim 33, where the polymer layer comprises an acrylic film to maintain optical clarity and color fastness.

35. A decorative laminate according to claim 1, wherein the underlay (c) is present and comprises a glass veil and a polymeric layer on one or both sides of the glass veil.

36. A decorative laminate according to claim 35, where the polymeric layer comprises a polyvinyl chloride film.

37. A decorative laminate according to claim 9, wherein underlay (c) is present, the printed paper decorative layer (b) is not treated with a resin and the laminate comprises an overlay of an aluminum oxide impregnated paper base treated with a melamine resin.

38. A decorative laminate according to claim 1, comprising an optional layer (a) said layers (b), (c) and (d) and also comprising on the opposite side of said layer (d), a second underlay, a second decorative layer, and optionally a second overlay layer.

39. A decorative laminate according to claim 1, comprising an optional layer (a) said underlay (c) and an overlay other than layer (a).

40. A decorative laminate according to claim 1, comprising said overlay (a), and an underlay other than layer (c).

41. Flooring comprising a decorative laminate according to claim 1.

42. Furniture or cabinets comprising a decorative laminate according to claim 1.

43. A laminate comprising
(i) a layer formed by preparing a non-woven, fibrous, fully or non-fully dispersed, wet-laid compound by mixing a suspension comprising a reinforcement material, at least one particulate thermoplastic polymer in an aqueous medium to form a white water slurry, dewatering the white water slurry to form a wet-laid compound impregnated with the particulate thermoplastic polymer, and drying and fusing the wet-laid compound to form a fiber-reinforced polymer layer, wherein the layer optionally includes colorants, and
(ii) a fiber reinforced polypropylene layer.

44. A laminate according to claim 43, wherein layers (i) and (ii) are adjacent to one another and no adhesive is therebetween, said particulate polymer comprises polyvinyl chloride, and said fiber reinforced polypropylene comprises glass-fiber reinforced polypropylene.
